(19) United States
(12) Patent Application Publication
(10) Pub. No.: US 2011/0153651 A1
(43) Pub. Date: Jun. 23, 2011

(54) APPARATUS AND METHOD FOR REMOTELY MONITORING TERMINAL

(75) Inventors: Soon Choul KIM, Daejeon (KR); Heejeong KIM, Daejeon (KR); Young Ho JEONG, Daejeon (KR); O Hyung KWON, Daejeon (KR)

(73) Assignee: Electronics and Telecommunications Research Institute, Daejeon (KR)

(21) Appl. No.: 12/898,380

(22) Filed: Oct. 5, 2010

(30) Foreign Application Priority Data
Dec. 21, 2009 (KR) 10-2009-0128454

(51) Int. Cl. G06F 15/16; G06F 17/30

(52) U.S. Cl. 707/769; 709/224; 707/E17.014

(57) ABSTRACT

An apparatus for remotely monitoring a terminal is provided which includes an analyzer to map terminal information regarding at least one management target terminal, a collection period, a cycle setting value, or an analysis item, to group the at least one management target terminal, and to store the grouped at least one management target terminal in a form of a profile, a management processor to perform a query for a Management Information Base (MIB) object requested by the at least one management target terminal conforming with a Simple Network Management Protocol (SNMP) standard, and to transmit a value of the returned MIB object to the analyzer, and an output unit to output, from a database, at least one of the analysis item, the analysis period, the terminal information, and an output format.

### CROSS-REFERENCE TO RELATED APPLICATION

This application claims the benefit of Korean Patent Application No. 10-2009-0128454, filed on Dec. 21, 2009, in the Korean Intellectual Property Office, the disclosure of which is incorporated herein by reference.

### BACKGROUND

1. Field of the Invention

The present invention relates to a method and apparatus of remotely monitoring a terminal, and more particularly, to a method and apparatus of remotely monitoring a performance, a fault, and a history state of a terminal in a Downloadable Conditional Access System (DCAS) headend server domain using a DCAS Host Management Information Base (MIB) equipped in a DCAS terminal that supports a DCAS.

2. Description of the Related Art

Recently, cable network providers providing cable broadcast channel services are greatly interested in a Downloadable Conditional Access System (DCAS) that is being studied as a scheme of flexibly operating a Conditional Access System (CAS), and are also interested in effectively reducing time and cost required for distribution, maintenance and repairing of a terminal, and for supporting clients.

The DCAS has a characteristic of providing a service to achieve online mutual authentication by downloading a Secure Micro (SM) client, instead of offline procedures performed in a conventional CAS.

A DCAS terminal forming a DCAS may include a DCAS Host Management Information Base (MIB) agent having parameters regarding state information, history information, error information, and performance level information that are associated with a downloaded SM client.

MIB information with the parameters is defined as individual data, and includes raw data. However, it is difficult for an operator to expect meaningful information only by obtained raw data.

Accordingly, there is a desire for a method to collect information regarding a terminal state and performance statistics from a DCAS Host MIB agent in a DCAS terminal by an operator that operates and manages a DCAS.

### SUMMARY

According to an aspect of the present invention, there is provided an apparatus for remotely monitoring a terminal, the apparatus including a monitoring information output unit to output real-time monitoring information, the real-time monitoring information being obtained by polling Management Information Base (MIB) information from a terminal in real-time; and an accumulated analysis information output unit to collect data based on target terminal information and a time scheduled conforming with a management policy that is set in advance, to process the collected data, to store the processed data, and to output accumulated analysis information, the accumulated analysis information being obtained in response to a request for a set analysis period.

According to another aspect of the present invention, there is provided an apparatus for remotely monitoring a terminal, the apparatus including an analyzer to map terminal information regarding at least one management target terminal, a collection period, a cycle setting value, or an analysis item, to group the at least one management target terminal, and to store the grouped at least one management target terminal in a form of a profile; a management processor to perform a query for an MIB object requested by the at least one management target terminal conforming with a Simple Network Management Protocol (SNMP) standard, and to transmit a value of the returned MIB object to the analyzer; and an output unit to output, from a database, at least one of the analysis item, the analysis period, the terminal information, and an output format.

According to another aspect of the present invention, there is provided a method of remotely monitoring a terminal, the method including outputting real-time monitoring information, the real-time monitoring information being obtained by polling MIB information from a terminal in real-time; and collecting data based on target terminal information and a time scheduled conforming with a management policy that is set in advance, processing the collected data, storing the processed data, and outputting accumulated analysis information, the accumulated analysis information being obtained in response to a request for a set analysis period.

According to another aspect of the present invention, there is provided a method of remotely monitoring a terminal, the method including mapping terminal information regarding at least one management target terminal, a collection period, a cycle setting value, or an analysis item; grouping the at least one management target terminal, and storing the grouped at least one management target terminal in a form of a profile; performing a query for an MIB object requested by the at least one management target terminal conforming with an SNMP standard; transmitting a value of the returned MIB object to an analyzer; and outputting, from a database, at least one of an analysis item, an analysis period, the terminal information, and an output format.

According to another aspect of the present invention, there is provided a method of remotely monitoring a terminal, the method including generating profile information regarding at least one management target terminal; collecting MIB information from the management target terminal at every collection period and every point of a collection cycle for the profile information; storing, in a database, the collected MIB information, terminal information regarding the management target terminal, and collection time information; processing the information stored in the database based on an analysis item of the profile information, and separately storing the processed information in the database; outputting a real-time analysis result value for each analysis item, when real-time analysis of information collected is requested; recollecting MIB information from the management target terminal, when an ending time of the collection period for the profile information is later than a current time; and terminating the collecting of the MIB information, when the ending time of the collection period for the profile information is earlier than the current time.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of an apparatus for remotely monitoring a terminal according to an embodiment of the present invention;

FIG. 2 is a flowchart illustrating a method of remotely monitoring a terminal according to an embodiment of the present invention;

FIG. 3 is a diagram illustrating analysis items to be analyzed by an apparatus for remotely monitoring a terminal according to an embodiment of the present invention;

FIG. 4 is a block diagram illustrating a configuration of an apparatus for remotely monitoring a terminal according to another embodiment of the present invention;

FIG. 5 is a block diagram further illustrating the configuration of the apparatus for remotely monitoring a terminal of FIG. 4;

FIG. 6 is a flowchart illustrating a method of remotely monitoring a terminal according to another embodiment of the present invention;

FIG. 7 is a flowchart illustrating a scheme of collecting information using an apparatus for remotely monitoring a terminal according to an embodiment of the present invention; and

FIG. 8 is a flowchart illustrating a scheme of analyzing information using an apparatus for remotely monitoring a terminal according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

According to an embodiment of the present invention, a management server may collect Management Information Base (MIB) data by remotely polling a target terminal using a Simple Network Management Protocol (SNMP). The management server may systematically make a database of data that is periodically collected for a fixed period, and may collect and process the data, so that the processed may be provided as meaningful information to a network operator. Here, the SNMP may be used as a standard protocol for managing a Transmission Control Protocol (TCP)/Internet Protocol (IP) network.

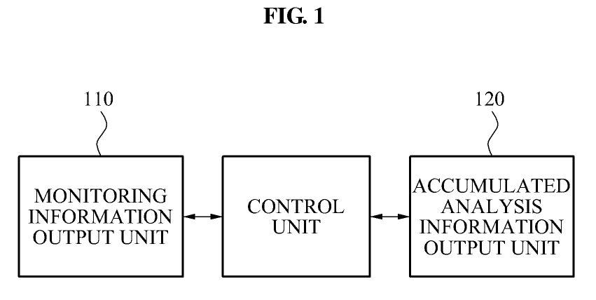

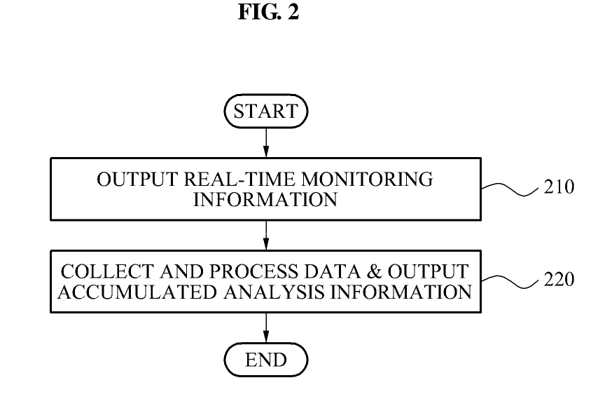

FIG. 1 is a block diagram illustrating a configuration of an apparatus for remotely monitoring a terminal according to an embodiment of the present invention, and FIG. 2 is a flowchart illustrating a method of remotely monitoring a terminal according to an embodiment of the present invention.

Referring to FIG. 1, the terminal remote monitoring apparatus of FIG. 1 includes a monitoring information output unit 110, and an accumulated analysis information output unit 120. Referring to FIG. 2, the monitoring information output unit 110 may output real-time monitoring information in operation 210. Here, the real-time monitoring information may be obtained by polling Management Information Base (MIB) information from a terminal in real-time. The accumulated analysis information output unit 120 may collect data based on target terminal information and a time scheduled conforming with a management policy that is set in advance, may process the collected data, may store the processed data, and may output accumulated analysis information in operation 220. Here, the accumulated analysis information may be obtained in response to a request for a set analysis period.

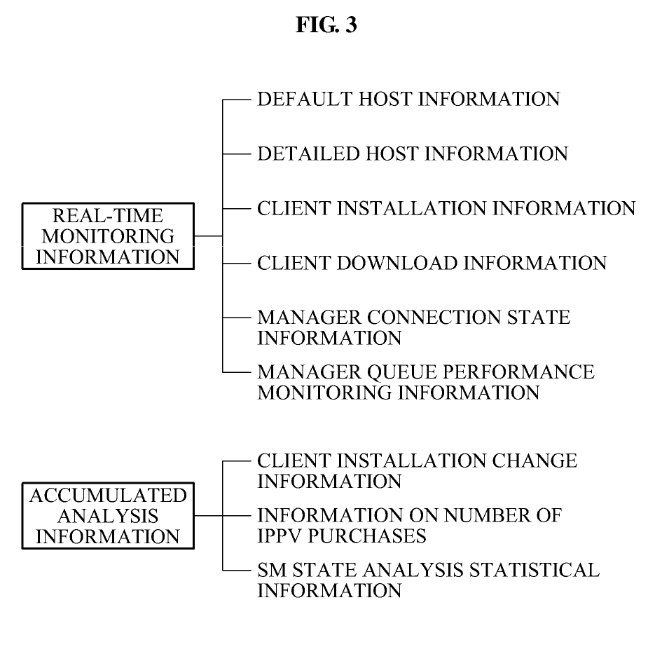

In other words, the terminal remote monitoring apparatus of FIG. 1 may derive and define analysis items based on a Downloadable Conditional Access System (DCAS) Host MIB, as shown in FIG. 3.

FIG. 3 is a diagram illustrating analysis items to be analyzed by an apparatus for remotely monitoring a terminal according to an embodiment of the present invention.

Referring to FIG. 3, the real-time monitoring information may be one of the analysis items analyzed by the terminal remote monitoring apparatus, and may include default host information, detailed host information, client installation information, client download information, manager connection state information, and manager queue performance monitoring information.

Additionally, the accumulated analysis information as another item among the analysis items may include client installation change information, information on a number of Impulse Pay Per View (IPPV) purchases, and Secure Micro (SM) state analysis statistical information.

Hereinafter, a scheme of analyzing a variety of information of FIG. 3 using the terminal remote monitoring apparatus of FIG. 1 will be described.

The terminal remote monitoring apparatus of FIG. 1 may analyze the default host information that is obtained by searching for terminal attribute information from an individual host connected to a network and by outputting the retrieved information. Here, the default host information may be input and output as shown in Table 1 below.

TABLE 1

| Input(s) | Outputs | Related objects |
|---|---|---|
| IP address(s) | SM ID, SM H/W | dcasHostSecureMicroInfo |
| | version, SM S/W | dcasHostSecureMicroKeyPairedTPId |
| | version, TP ID, | dcasHostAuthenticationProxyUniqueId |
| | AP information | |

Additionally, the terminal remote monitoring apparatus of FIG. 1 may analyze the detailed host information that is obtained by searching for detailed terminal attribute information from the individual host connected to the network and by outputting retrieved information. Here, the detailed host information may be input and output as shown in Table 2 below.

TABLE 2

| Input(s) | Outputs | Related objects |
|---|---|---|
| IP address(s) | SM ID, SM H/W | dcasHostSecureMicroInfo |
| | version, SM S/W | dcasHostSecureMicroKeyPairedTPId |
| | version, TP ID, | dcasHostSecureMicroState |
| | SM state, SM | dcasHostSecureMicroKeyPairingState |
| | Key Pairing State, | dcasHostAuthenticationProxyUniqueId |
| | AP information, | dcasHostIppvPurchases |
| | Number of IPPVs | |

The terminal remote monitoring apparatus of FIG. 1 may analyze the client installation information obtained by receiving a client type list from the terminal through a query and by outputting detailed installation information regarding a client type in the received client type list. Here, the client type list may be a list of types of clients installed in the individual host. The client installation information may be input and output as shown in Table 3 below.

TABLE 3

| Inputs | Outputs | Related objects |
|---|---|---|
| IP address, | SM ID, Client ID, | dcasHostSecureMicroInfo |
| Client type | Client priority, Client | dcasHostSecureMicroCurrentClientID |
| (cas, asd, drm) | vendor, Client version, | dcasHostSecureMicroCurrentClientPriority |
| | Client installation | dcasHostSecureMicroCurrentClientVendor |
| | time | dcasHostSecureMicroCurrentClientVersion |
| | | dcasHostSecureMicroCurrentClientDateLoaded |

The terminal remote monitoring apparatus of FIG. 1 may analyze the client download information that indicates detailed information and a download state of a client in which a download is being performed or is completed. Here, the client download information may be input and output as shown in Table 4 below.

TABLE 4

| Inputs | Outputs | Related objects |
|---|---|---|
| IP address, | SM ID, Download | dcasHostSecureMicroInfo |
| Table | state, URL | dcasHostSecureMicroClientDownloadIndex |
| index, | information, | dcasHostSecureMicroClientDownloadStatus |
| Collection | Client type, Client | dcasHostSecureMicroClientDownloadUrl |
| cycle | providing vendor, | dcasHostSecureMicroClientDownloadType |
| (seconds) | Client version, | dcasHostSecureMicroClientDownloadVendor |
| | Download start | dcasHostSecureMicorClientDownloadVersion |
| | time, Download | dcasHostSecureMicroClientDownloadStartTime |
| | end time, Rate of | dcasHostSecureMicroClientDownloadEndTime |
| | downloading | dcasHostSecureMicroClientDownloadPercentComplete |
| | progression (%), | dcasHostSecureMicroClientDownloadTransfer |
| | SM transfer rate | PercentComplete |
| | (%) | |

The terminal remote monitoring apparatus of FIG. 1 may analyze the manager connection state information that indicates information regarding a current connection state that is in a form of a table and is provided by a operating system. The manager connection state information may be input and output as shown in Table 5 below.

TABLE 5

| Inputs | Outputs | Related objects |
|---|---|---|
| IP address, | SM ID, Connection ID, | dcasHostSecureMicroInfo |
| Top N | Connection type, | dcasHostDcasManagerConnectionTableIndex |
| | Connection type data, | dcasHostDcasManagerConnectionId |
| | Connection client type, | dcasHostDcasManagerConnectionType |
| | Connection subject ID | dcasHostDcasManagerConnectionTypeData |
| | | dcasHostDcasManagerConnectionClientType |
| | | dcasHostDcasManagerConnectionEntityID |

The terminal remote monitoring apparatus of FIG. 1 may analyze the manager queue performance monitoring information that indicates a performance index of at least one queue provided by the operating system. Here, the manager queue performance monitoring information may be input and output as shown in Table 6 below.

TABLE 6

| Inputs | Outputs | Related objects |
|---|---|---|
| IP address, | SM ID, Queue ID, | dcasHostSecureMicroInfo |
| Collection | Number of current | dcasHostDCASManagerQueueId |
| cycle, Top | messages (N), Number | dcasHostDCASManagerNumberofMessages |
| N | of dropped messages | dcasHostDCASManagerNumberofDroppedMessages |
| | (F), Number of passed | dcasHostDCASManagerNumberofPassedMessages |
| | messages (P), Message | |
| | failure rate | |
| | (F/(N + F + P) * 100) | |

The terminal remote monitoring apparatus of FIG. 1 may analyze the client installation change information that is obtained by analyzing history information regarding a client installation change of the terminal based on collected object information during the analysis period, and by outputting the analyzed history information. Here, the client installation change information may be input and output as shown in Table 7 below.

TABLE 7

| Inputs | Outputs | Related objects |
|---|---|---|
| SM ID, | Client ID, Client | dcasHostSecureMicroCurrentClientID |
| Analysis | vendor, Client version, | dcasHostSecureMicroCurrentClientVendor |
| period | Installation time, | dcasHostSecureMicroCurrentClientVersion |
| | Uninstallation time | dcasHostSecureMicroCurrentClientDateLoaded |
| | | dcasHostSecureMicroPreviousClientID |
| | | dcasHostSecureMicroPreviousClientVendor |
| | | dcasHostSecureMicroPreviousClientVersion |
| | | dcasHostSecureMicroPreviousClientDateUnloaded |

Additionally, the terminal remote monitoring apparatus of FIG. 1 may store the client installation change information using the following scheme.

Specifically, the terminal remote monitoring apparatus of FIG. 1 may query the terminal for a related value, based on SNMP-get-request and SNMP-get-response.

Subsequently, the terminal remote monitoring apparatus of FIG. 1 may store the returned value in a new record in a sequence of a collection time, an SM ID, and the information on the number of IPPV purchases.

The terminal remote monitoring apparatus of FIG. 1 may also analyze the client installation change information using the following scheme.

Specifically, the terminal remote monitoring apparatus of FIG. 1 may select at least one record from a storage unit based on an analysis period and terminal information, for example an SM ID of the terminal.

Subsequently, the terminal remote monitoring apparatus of FIG. 1 may compare dcasHostSecureMicroCurrentClientID with dcasHostSecureMicroPreviousClientID from the selected at least one record in a counterclockwise manner, and may output a client installation history as shown in Table 8 below.

TABLE 8
Outputs

| | | | | | |
|---|---|---|---|---|---|
| <N + 1 | ClientID | Client | Client | Installation | Uninstallation |
| th> | | vendor | version | time | time |
| <N th> | ClientID | Client | Client | Installation | Uninstallation |
| | | vendor | version | time | time |

According to an embodiment of the present invention, the client installation history may include a client ID, a client vendor, a client version, an installation time, an uninstallation time, and the like.

When two values are different, the terminal remote monitoring apparatus of FIG. 1 may determine that non-collected information N'th have existed for a time between Nth and N+1th, so that an “uninstallation time” field corresponding to Nth and an “installation time” field corresponding to N+1th remain blank as shown in FIG. 9. In other words, the analyzed information may be output as a result value of N as shown in Table 9 below.

TABLE 9
Outputs

| | | | | | |
|---|---|---|---|---|---|
| <N + 1 | ClientID | Client | Client | Installation | Uninstallation |
| th> | | vendor | version | time | time |
| <N′ th> | ClientID | Client | Client | — | Uninstallation |
| | | vendor | version | | time |
| <N th> | ClientID | Client | Client | Installation | — |
| | | vendor | version | time | |

The terminal remote monitoring apparatus of FIG. 1 may analyze the information on the number of IPPV purchases that is obtained by analyzing a change rate of a number of IPPVs that are not collected during the analysis period and by outputting the analyzed change rate. Here, the information on the number of IPPV purchases may be input and output as shown in Table 10 below.

TABLE 10

| Inputs | Output | Related objects |
|---|---|---|
| SM ID, | Number of IPPVs | dcasHostIppvPurchases |
| Analysis period | | |

Additionally, the terminal remote monitoring apparatus of FIG. 1 may store the information on the number of IPPV purchases using the following scheme.

Specifically, the terminal remote monitoring apparatus of FIG. 1 may query the terminal for a related value, based on SNMP-get-request and SNMP-get-response.

Subsequently, the terminal remote monitoring apparatus of FIG. 1 may store the returned value in a new record in a sequence of a collection time, an SM ID, and the information on the number of IPPV purchases.

The terminal remote monitoring apparatus of FIG. 1 may also analyze the information on the number of IPPV purchases using the following scheme.

Specifically, the terminal remote monitoring apparatus of FIG. 1 may select at least one record from a database based on the analysis period and the terminal information, for example the SM ID of the terminal.

Subsequently, the terminal remote monitoring apparatus of FIG. 1 may output, from the selected at least one record, a change in the information on the number of IPPV purchases based on a change in time.

For example, the terminal remote monitoring apparatus of FIG. 1 may use a graph with a broken line to show the change in the information on the number of IPPV purchases based on the change in time. Here, the change in the information on the number of IPPV purchases may be output only when a value of the number of IPPV purchases is changed during an interval between analysis points t and t+1.

When a PurchaseReport message is generated even when values of t and t+1 are identical to each other, the terminal remote monitoring apparatus of FIG. 1 may display a PurchaseReport event, and may output changed information. Here, the PurchaseReport message may be one of DCAS protocol messages.

The terminal remote monitoring apparatus of FIG. 1 may analyze the SM state analysis statistical information that is obtained by analyzing a state of a terminal during the analysis period and by outputting analysis statistics based on a combination of each state. Here, the SM state analysis statistical information may be input and output as shown in Table 11 below.

TABLE 11

| Inputs | Outputs | Related objects |
|---|---|---|
| SM ID, | Rates by state, | dcasHostSecureMicroState |
| Analysis | Terminal information | dcasHostSecureMicroKeyPairingStae |
| period | based on each rate | |
| | (that will be output | |
| | based on user | |
| | selection) | |

Additionally, the SM state analysis statistical information may be collected as follows.

Specifically, the terminal remote monitoring apparatus of FIG. 1 may query the terminal for a related value, based on SNMP-get-request and SNMP-get-response.

Subsequently, the terminal remote monitoring apparatus of FIG. 1 may collect, as the returned value, information regarding a host SM state and a host SM key paring state, and may store the returned value in a new record in a sequence of a collection time, an SM ID, SM state information, and SM key paring state information.

The SM state analysis statistical information may be analyzed as follows.

Specifically, the terminal remote monitoring apparatus of FIG. 1 may select records from a storage unit based on an analysis period.

Subsequently, the terminal remote monitoring apparatus of FIG. 1 may output, from the selected records, a change in information on a number of IPPV purchases based on a change for each fixed time slot, namely a collection time, in the form of a graph with a broken line. Here, the change in the information on the number of IPPV purchases may be output only when a value of the number of IPPV purchases is changed during an interval between analysis points t and t+1.

When a PurchaseReport message is generated even when values of t and t+1 are identical to each other, the terminal remote monitoring apparatus of FIG. 1 may display a PurchaseReport event, and may output changed information. Here, the PurchaseReport message may be one of DCAS protocol messages.

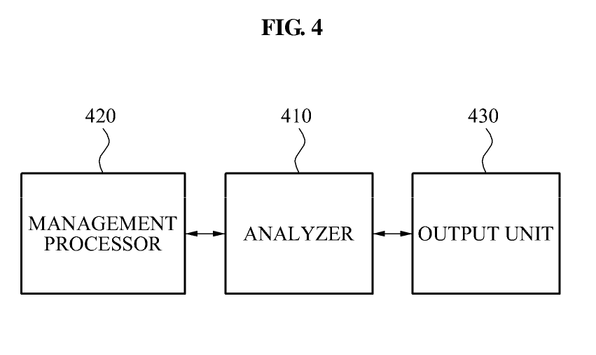

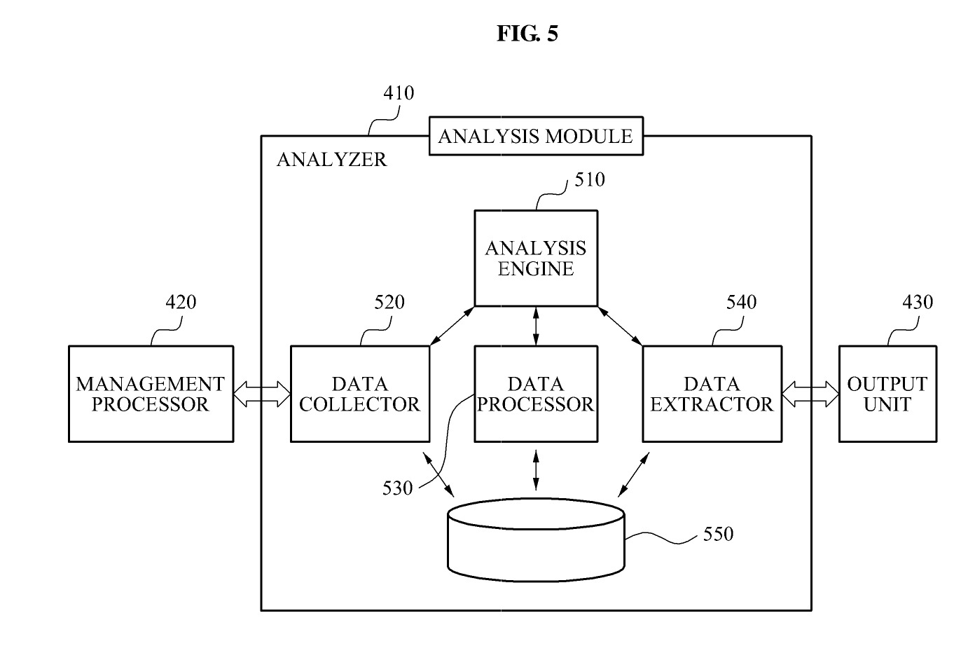

As described above, the terminal remote monitoring apparatus of FIG. 1 may be applied to an MIB manager system based on the analyzed information, and may be configured as shown in FIGS. 4 and 5.

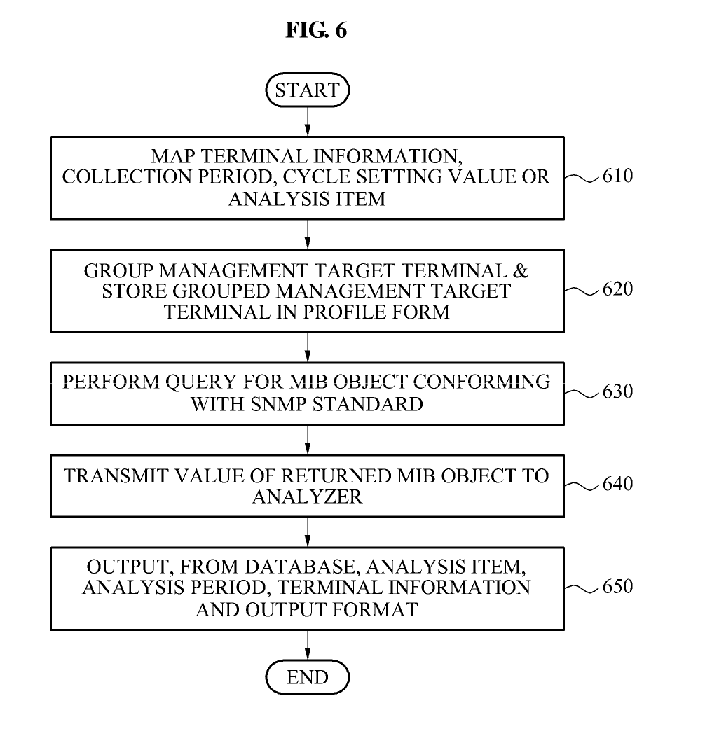

FIG. 4 is a block diagram illustrating a configuration of a terminal remote monitoring apparatus according to another embodiment of the present invention, FIG. 5 is a block diagram further illustrating the configuration of the terminal remote monitoring apparatus of FIG. 4, and FIG. 6 is a flowchart illustrating a method of remotely monitoring a terminal according to another embodiment of the present invention.

As shown in FIG. 4, the terminal remote monitoring apparatus includes an analyzer 410, a management processor 420, and an output unit 430.

As shown in FIG. 5, the analyzer 410 of the terminal remote monitoring apparatus of FIG. 4 includes an analysis engine 510, a data collector 520, a data processor 530, and a data extractor 540.

Referring to FIG. 6, in operation 610, the analyzer 410 may map terminal information regarding at least one management target terminal, a collection period, a cycle setting value, or an analysis item.

In operation 620, the analyzer 410 may group the at least one management target terminal, and may store the grouped at least one management target terminal in a form of a profile.

Here, the data collector 520 may receive target information, and may transmit the received target information to the management processor 420 functioning as an entity implementing an SNMP. The target information may be used to collect information regarding an MIB object, and may include, for example, an IP address for the management target terminal, MIB parameters, and a collection period.

When a value of the MIB object returned by query is received, a database 550 of the terminal remote monitoring apparatus of FIG. 4 may periodically and sequentially store a profile ID, terminal information, a collection time, an MIB ID, and the value of the returned MIB object.

The data processor 530 may process the information regarding the MIB object collected by the data collector to be available data based on an analysis item that is set in advance, and may store the processed data in the database 550.

In operation 630, the management processor 420 may perform a query for an MIB object requested by the at least one management target terminal, conforming with an SNMP standard.

In operation 640, the management processor 420 may transmit a value of the returned MIB object to the analyzer 410.

Here, the data extractor 540 may select at least one data of the analysis item, the analysis period, the management target terminal, and the output format from the database 550 that stores the data processed by the data processor 530, and may transmit the selected data to the output unit 430.

In operation 650, the output unit 430 may output, from the database 550, at least one of the analysis item, the analysis period, the terminal information, and the output format.

The analysis engine 510 may function to systematically connect operations of the data collector 520, the data processor 530, and the data extractor 540.

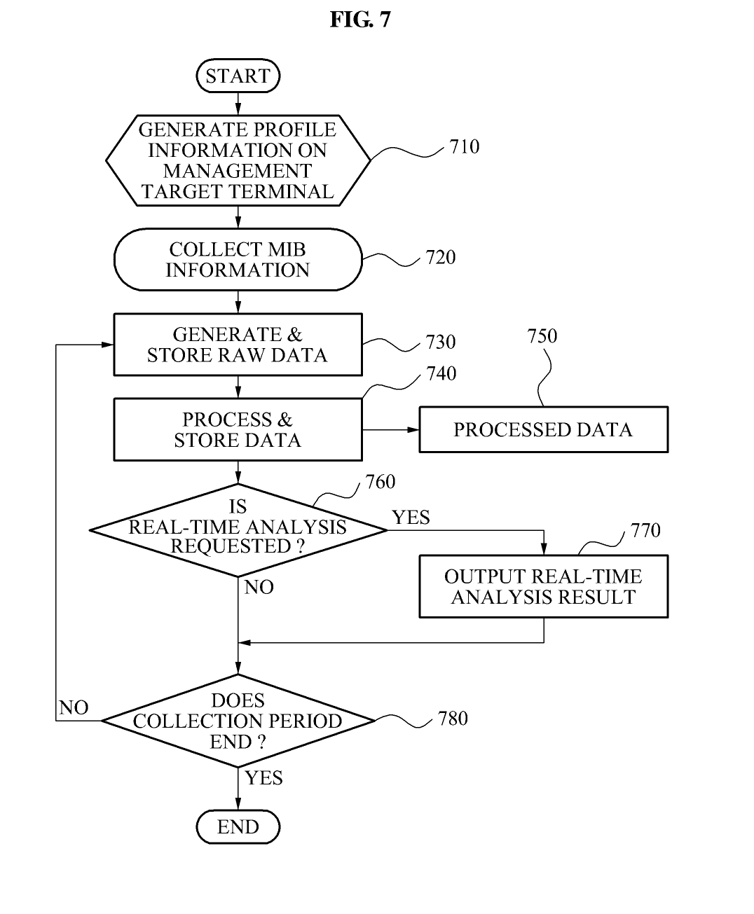

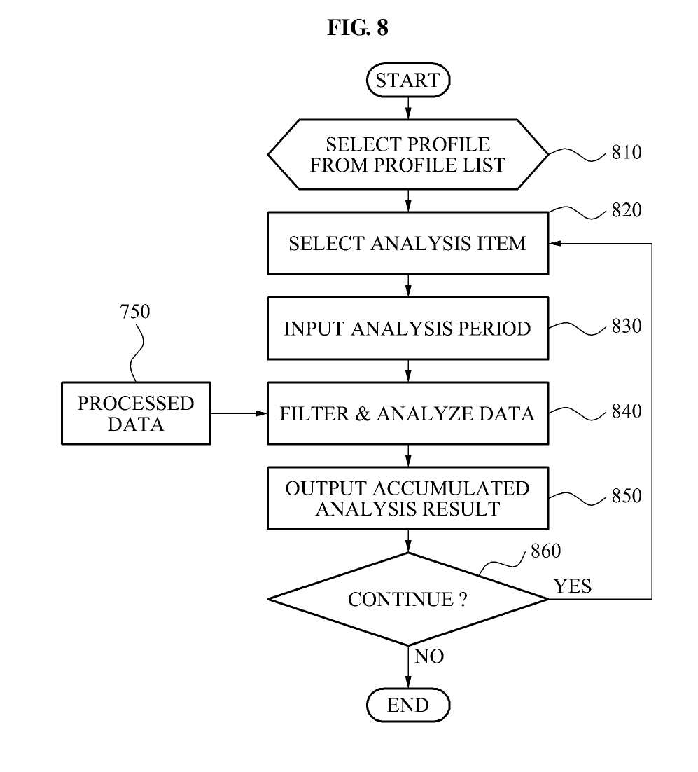

Hereinafter, a scheme of collecting and analyzing information using a terminal remote monitoring apparatus according to an embodiment of the present invention will be described with reference to FIGS. 7 and 8.

Specifically, the scheme of collecting information will be described with reference to FIG. 7.

FIG. 7 is a flowchart illustrating a scheme of collecting information using a terminal remote monitoring apparatus according to an embodiment of the present invention.

In operation 710, the terminal remote monitoring apparatus may generate profile information regarding at least one management target terminal.

In operation 720, the terminal remote monitoring apparatus may collect MIB information from the management target terminal at every collection period and every point of a collection cycle for the profile information.

In operation 730, the terminal remote monitoring apparatus may store, in a database, the collected MIB information, terminal information regarding the management target terminal, and collection time information.

Here, the data collected in operation 720 may be appropriately processed for each analysis item contained in the profile information, and the processed data may be separately stored in a corresponding database in operation 750.

In operation 740, the terminal remote monitoring apparatus may process the information stored in the database for each analysis item contained in the profile information, and may separately store the processed information in the database.

In operation 760, the terminal remote monitoring apparatus may determine whether real-time analysis of information collected is requested. When the real-time analysis is determined to be requested, the terminal remote monitoring apparatus may output a real-time analysis result value for each analysis item in operation 770.

In operation 780, the terminal remote monitoring apparatus may determine whether the collection period ends. When an ending time of the collection period for the profile information is later than a current time, the terminal remote monitoring apparatus may recollect MIB information from the management target terminal in operation 780.

Conversely, when the ending time of the collection period for the profile information is earlier than the current time, the terminal remote monitoring apparatus may terminate the collecting of the MIB information.

Hereinafter, the scheme of analyzing information will be described with reference to FIG. 8.

FIG. 8 is a flowchart illustrating a scheme of analyzing information using a terminal remote monitoring apparatus according to an embodiment of the present invention.

In operation 810, the terminal remote monitoring apparatus may select a profile containing the management target terminal from a profile list.

In operation 820, the terminal remote monitoring apparatus may receive a signal to select an analysis item based on the selected profile.

In operation 830, the terminal remote monitoring apparatus may receive a signal to input a predetermined analysis period within a storage period based on the MIB information.

In operation 840, the terminal remote monitoring apparatus may perform filtering and analyzing of the analysis item during the analysis period based on the processed data of operation 750.

In operation 850, the terminal remote monitoring apparatus may output an accumulated analysis result based on a result of the filtering and analyzing.

In operation 860, the terminal remote monitoring apparatus may determine whether to continue to analyze another analysis item in the selected profile. When an analysis instruction signal is received in operation 860, operation flow may be returned to operation 820. Conversely, when a termination instruction signal is received in operation 860, the terminal remote monitoring apparatus may terminate the analyzing scheme.

According to embodiments of the present invention, it is possible to define analysis items in order that an operator that operates and manages a DCAS may collect information regarding a terminal state and performance statistics from a DCAS Host MIB agent equipped in a DCAS terminal.

Additionally, according to the embodiments of the present invention, it is possible to remotely monitor a software download state or a performance of DCAS terminals supporting a DCAS, based on data accumulated in real-time or for a fixed period, by using a DCAS Host MIB agent, without needing to physically visit the DCAS terminals.

Furthermore, according to the embodiments of the present invention, it is possible to remotely monitor performance level information, error information, and a history state of a terminal in a DCAS headend server domain using a DCAS Host MIB agent equipped in a DCAS terminal.

Moreover, according to the embodiments of the present invention, a scheme may be provided to increase a terminal management performance of a DCAS headend server domain, and to reduce a management cost by an efficient terminal management.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for remotely monitoring a terminal, the apparatus comprising:
a monitoring information output unit to output real-time monitoring information, the real-time monitoring information being obtained by polling Management Information Base (MIB) information from a terminal in real-time; and
an accumulated analysis information output unit to collect data based on target terminal information and a time scheduled conforming with a management policy that is set in advance, to process the collected data, to store the processed data, and to output accumulated analysis information, the accumulated analysis information being obtained in response to a request for a set analysis period.

2. The apparatus of claim 1, wherein the real-time monitoring information comprises:
default host information obtained by searching for terminal attribute information from an individual host and by outputting retrieved information, the individual host being connected to a network; and
detailed host information obtained by searching for detailed terminal attribute information from the individual host and by outputting retrieved information.

3. The apparatus of claim 2, wherein the real-time monitoring information further comprises:
client installation information obtained by receiving a client type list from the terminal through a query and by outputting detailed installation information regarding a client type in the received client type list, the client type list being a list of types of clients installed in the individual host; and
client download information indicating detailed information and a download state of a client in which a download is being performed or is completed.

4. The apparatus of claim 2, wherein the real-time monitoring information further comprises:
manager connection state information indicating information regarding a current connection state in a form of a table, the information being provided by a operating system; and
manager queue performance monitoring information indicating a performance index of at least one queue provided by the operating system.

5. The apparatus of claim 1, wherein the accumulated analysis information comprises:
client installation change information obtained by analyzing history information regarding a client installation change of the terminal based on collected object information during the analysis period, and by outputting the analyzed history information; and
information on a number of Impulse Pay Per View (IPPV) purchases obtained by analyzing a change rate of a number of IPPVs that are not collected during the analysis period and by outputting the analyzed change rate.

6. The apparatus of claim 5, wherein the accumulated analysis information further comprises:
Secure Micro (SM) state analysis statistical information obtained by analyzing a state of a terminal during the analysis period and by outputting analysis statistics based on a combination of each state.

7. An apparatus for remotely monitoring a terminal, the apparatus comprising:
an analyzer to map terminal information regarding at least one management target terminal, a collection period, a cycle setting value, or an analysis item, to group the at least one management target terminal, and to store the grouped at least one management target terminal in a form of a profile;
a management processor to perform a query for an MIB object requested by the at least one management target terminal conforming with a Simple Network Management Protocol (SNMP) standard, and to transmit a value of the returned MIB object to the analyzer; and
an output unit to output, from a database, at least one of the analysis item, the analysis period, the terminal information, and an output format.

8. The apparatus of claim 7, wherein the analyzer comprises a data collector to receive target information and to transmit the received target information to the management processor, the target information being used to collect information regarding the MIB object, and the management processor functioning as an entity implementing an SNMP.

9. The apparatus of claim 8, wherein the analyzer further comprises a database to periodically and sequentially store a profile identifier (ID), terminal information, a collection time, an MIB ID, and the value of the returned MIB object, when the value of the returned MIB object is received.

10. The apparatus of claim 9, wherein the analyzer further comprises a data processor to process the information regarding the MIB object collected by the data collector to be available data based on an analysis item, set in advance, and to store the processed data in the database.

11. The apparatus of claim 10, wherein the analyzer further comprises a data extractor to select at least one data of the analysis item, the analysis period, the management target terminal, and the output format from the database, and to transmit the selected at least one data to the output unit.

12. The apparatus of claim 10, wherein the analyzer further comprises an analysis engine to systematically connect operations of the data collector, the data processor, and the data extractor.

13. A method of remotely monitoring a terminal, the method comprising:
outputting real-time monitoring information, the real-time monitoring information being obtained by polling MIB information from a terminal in real-time; and
collecting data based on target terminal information and a time scheduled conforming with a management policy that is set in advance, processing the collected data, storing the processed data, and outputting accumulated analysis information, the accumulated analysis information being obtained in response to a request for a set analysis period.

14. The method of claim 13, wherein the collecting comprises:
selecting at least one record from a storage unit based on an analysis period and terminal information of the terminal; and
comparing dcasHostSecureMicroCurrentClientID with dcasHostSecureMicroPreviousClientID from the selected at least one record in a counterclockwise manner, and outputting a client installation history.

15. The method of claim 14, wherein the collecting further comprises:
querying the terminal for a related value based on SNMP-get-request and SNMP-get-response; and
storing the returned value in a new record in a sequence of a collection time, an SM ID, and information on a number of IPPV purchases.

16. The method of claim 15, wherein the collecting further comprises:
selecting at least one record from a database based on the terminal information and the analysis period; and
outputting, from the selected record, a change in the information on the number of IPPV purchases based on a change in time.

17. The method of claim 15, wherein the collecting further comprises:
collecting the returned value, and storing the returned value in a new record in a sequence of a collection time, an SM ID, SM state information, and SM key paring state information, the returned value being information regarding a host SM state, and a host SM key paring state.

18. A method of remotely monitoring a terminal, the method comprising:
mapping terminal information regarding at least one management target terminal, a collection period, a cycle setting value, or an analysis item;
grouping the at least one management target terminal, and storing the grouped at least one management target terminal in a form of a profile;
performing a query for an MIB object requested by the at least one management target terminal conforming with an SNMP standard;
transmitting a value of the queried MIB object to an analyzer; and
outputting, from a database, at least one of an analysis item, an analysis period, the terminal information, and an output format.

19. A method of remotely monitoring a terminal, the method comprising:
generating profile information regarding at least one management target terminal;
collecting MIB information from the management target terminal at every collection period and every point of a collection cycle for the profile information;
storing, in a database, the collected MIB information, terminal information regarding the management target terminal, and collection time information;
processing the information stored in the database based on an analysis item of the profile information, and separately storing the processed information in the database;
outputting a real-time analysis result value for each analysis item, when real-time analysis of information collected is requested;
recollecting MIB information from the management target terminal, when an ending time of the collection period for the profile information is later than a current time; and
terminating the collecting of the MIB information, when the ending time of the collection period for the profile information is earlier than the current time.

20. The method of claim 19, further comprising:
selecting a profile comprising the management target terminal from a profile list;
receiving a signal to select an analysis item based on the selected profile;
receiving a predetermined analysis period within a storage period based on the MIB information;
performing filtering and analyzing of the analysis item during the predetermined analysis period;
outputting an accumulated analysis result based on a result of the filtering and analyzing; and
determining whether to continue to analyze another analysis item in the selected profile.
